(19) United States
(12) Patent Application Publication
(10) Pub. No.: US 2015/0113633 A1
(43) Pub. Date: Apr. 23, 2015

(54) ELECTRONIC DEVICE AND AUTHENTICATION METHOD USING PASSWORD THEREOF

(71) Applicant: Samsung Electronics Co., Ltd., Gyeonggi-do (KR)

(72) Inventor: Donghyun Yeom, Gyeonggi-do (KR)

(21) Appl. No.: 14/522,497

(22) Filed: Oct. 23, 2014

(30) Foreign Application Priority Data
Oct. 23, 2013 (KR) 10-2013-0126330

(51) Int. Cl. H04L 29/06

(52) U.S. Cl. CPC H04L 63/083
USPC 726/18; 726/19

(57) ABSTRACT

An authentication method using a password of an electronic device is provided. The method includes receiving a password. The method also includes determining whether the received password coincides with a password stored in advance. The method further includes determining whether an input condition at the time of password input coincides with a password input condition stored in advance when the received password coincides with the password stored in advance. The method includes executing a function when the input condition at the time of password input coincides with the password input condition stored in advance.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0126330, filed on Oct. 23, 2013, which is hereby incorporated by reference for all purposes as if fully set forth herein.

### TECHNICAL FIELD

The present disclosure relates generally to an authentication method using a password of an electronic device to which a user inputs a password according to preset input conditions and an electronic device using the same.

### BACKGROUND

In general, mobile devices, such as a wearable device including a smart phone, a tablet PC, a portable multimedia player (PMS), a personal digital assistant (PDA), a laptop personal computer (PC), a wrist watch, and a head-mounted device (HMD), are weak in personal information security as compared with personal computers (PCs) used at homes or offices. In the personal computer (PC), password input for function execution is performed at a fixed personal place, but in the mobile device, since password input for function execution is performed at a public place or during movement, a personal password may be exposed to others.

### SUMMARY

The present disclosure relates to an electronic device and an authentication method using a password thereof. To address the above-discussed deficiencies, it is a primary object to provide a method capable of inputting a password according to input conditions recognized only by a user.

In a first example, an image authentication method using a password of an electronic device is provided. The method includes receiving a password. The method also includes determining whether the received password coincides with a password stored in advance. The method further includes determining whether an input condition at a time of password input coincides with a password input condition stored in advance when the received password coincides with the password stored in advance. The method includes executing a function when the input condition at the time of password input coincides with the password input condition stored in advance.

In a second example, an electronic device is provided. The electronic device includes a user input unit configured to receive a password from a user. The electronic device also includes a memory unit configured to store a password stored in advance and an input condition of the password stored in advance. The electronic device further includes a control unit configured to determine whether the received password coincides with the password stored in advance, determine whether an input condition at a time of password input coincides with the input condition of the password stored in advance when the received password coincides with the password stored in advance, and execute a function when the input condition at the time of password input coincides with the input condition of the password stored in advance. The electronic device includes a display unit configured to display the function executed by the control unit.

In a third example, a password is input according to input conditions recognized only by a user, so that it is possible to protect personal information even though the password is exposed to others.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example configuration of an electronic device according to this disclosure;

FIG. 2 is a block diagram illustrating an example configuration of a control unit according to this disclosure;

FIG. 3 is a flowchart illustrating an authentication method using a password of an electronic device according to this disclosure;

FIG. 4 is a flowchart illustrating an example password setting method of an electronic device according to this disclosure; and

FIGS. 5A, 5B, 6A, 6B, 7, 8A, 8B, 9A and 9B are diagrams illustrating example authentication methods using a password of an electronic device according to this disclosure.

### DETAILED DESCRIPTION

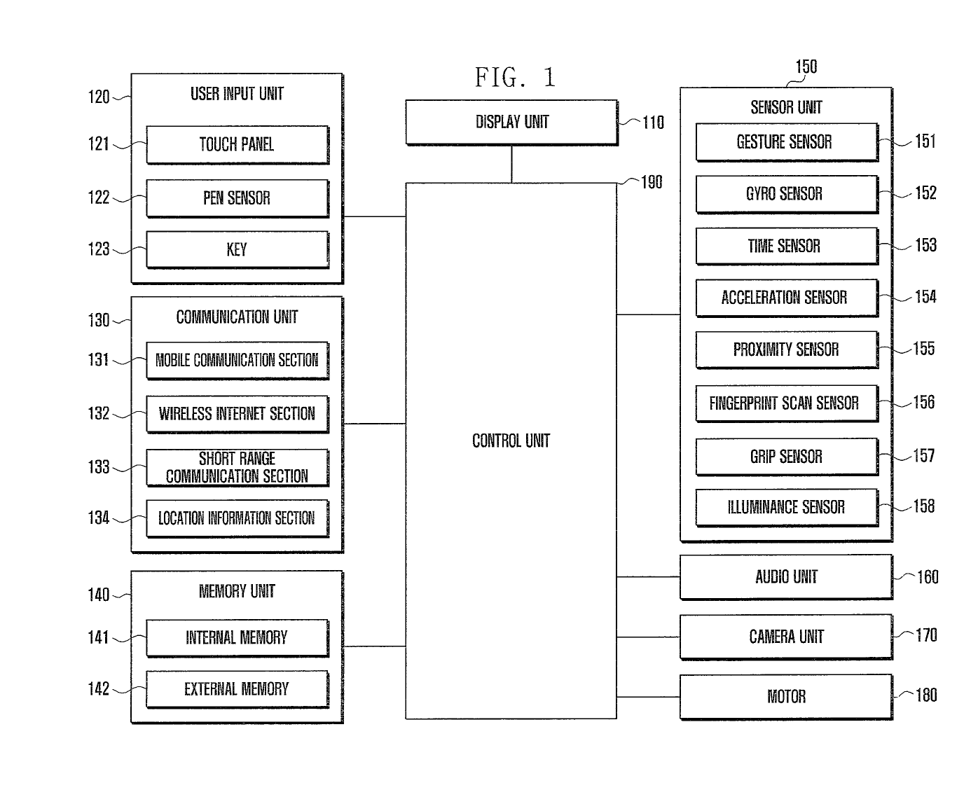

FIGS. 1 through 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, embodiments of this disclosure will be described with reference to the accompanying drawings to describe the present disclosure in detail so that the technical idea of the present disclosure can be easily implemented by those skilled in the art.

FIG. 1 is a block diagram illustrating a configuration of an electronic device 100 disclosure according to this disclosure.

The configuration of the electronic device 100 according to this disclosure can be applied to a smart phone, but is not limited thereto and can be applied to various devices. For example, the configuration of the electronic device 100 can be applied to a tablet PC, a Portable Multimedia Player (PMP), a Personal Digital Assistant (PDA), a laptop PC, and a wearable device such as a wrist watch and a Head-Mounted Display (HMD).

The electronic device 100 includes a display unit 110, a user input unit 120, a communication unit 130, a memory unit 140, a sensor unit 150, an audio unit 160, a camera unit 170, a motor 180, and a control unit 190.

The display unit 110 performs a function of displaying an image or data to a user. The display unit 110 includes a display panel. As the display panel, for example, a liquid crystal display (LCD), an active-matrix organic light-emitting diode (AM-OLED) and the like can be used. The display unit 110 further includes a controller that controls the display panel. The display panel, for example, can be implemented to be flexible, transparent, or wearable.

The display unit 110 can be combined with a touch panel 121 to be provided in the form of a touchscreen. For example, the touchscreen includes an integral type module in which a display panel and a touch panel are combined in a stack structure. The user input unit 120 receives various commands from a user. The user input unit 120, for example, includes at least one of the touch panel 121, a pen sensor 122, and a key 123.

The touch panel 121, for example, recognizes touch input by a user in at least one of a capacitive type, a resistive type, an infrared type, and an ultrasonic type. The touch panel 121 can further include a controller. In the capacitive type, proximate recognition is also possible in addition to a direct touch. The touch panel 121 further includes a tactile layer. In this case, the touch panel 121 provides a user with a tactile reaction. The pen sensor 122, for example, can be implemented using a separate sheet for pen recognition in the same manner as the reception of touch input of a user. The key 123, for example, can include a mechanical key, a touch key and the like. The mechanical key, for example, includes at least one of a power button, which is provided at one side of the electronic device 100 and turns on the display of the electronic device 100 when the mechanical key is pushed, one or more volume buttons, which are provided at the other side of the electronic device 100 and control volume when the volume buttons are pushed, and a home button which is provided at the center of a lower end of the display unit 110 of the electronic device 100 and performs transfer to a home screen when the home button is pushed. The touch key, for example, includes at least one of a menu key, which is provided at one surface of the lower end of the display unit 110 of the electronic device 100 and provides a menu related to content being currently displayed when the menu key is pushed, and a return key which is provided at the other surface of the lower end of the display unit 110 of the electronic device 100 and provides a function of returning to a previous screen of a screen being currently displayed when the return key is pushed.

The communication unit 130 includes at least one of a mobile communication section 131, a wireless Internet section 132, a short range communication section 133, and a location information section 134.

The mobile communication section 131 transmits/receives a wireless signal to/from at least one of a base station, an external terminal, and a server in a mobile communication network. The wireless signal can include a voice call signal, an image communication call signal, or various types of data according to the transmission/reception of a text/multimedia message.

The wireless Internet section 132 performs a function for wireless Internet access. A wireless LAN (WLAN) (Wi-Fi), Wireless broadband (Wibro), World Interoperability for Microwave Access (Wimax), High Speed Downlink Packet Access (HSDPA) and the like can be used as a wireless Internet technology.

The short range communication section 133 performs a function for short range communication. A Bluetooth, radio frequency identification (RFID), infrared data association (IrDA), ultra wideband (UWB), ZigBee and the like can be used as a short range communication technology.

The location information section 134 performs a function of acquiring or checking the location of a mobile terminal. The location information section 134 acquires location information by using a global navigation satellite system (GNSS). The global navigation satellite system (GNSS) is a term used in order to describe wireless navigation satellite systems that orbit the earth and transmit reference signals used when a predetermined type of wireless navigation receivers decide their location on the surface of the earth or around the surface of the earth. The global navigation satellite system (GNSS) can include a global position system (GPS) operated in USA, Galileo operated in Europe, global orbiting navigational satellite system (GLONASS) operated in Russia, COMPASS operated in China, quasi-zenith satellite system (QZSS) operated in Japan, and the like.

In addition, the communication unit 130 includes a network interface (for example, a LAN card), a modem and the like for connecting the electronic device 100 to networks (for example, the Internet, a local area network (LAN), a wide area network (WAN), a telecommunication network, a cellular network, a satellite network, a plain old telephone service (POTS) and the like).

The memory unit 140 includes at least one of an internal memory 141 and an external memory 142.

The internal memory 141, for example, can include at least one of a volatile memory (for example, a dynamic RAM (DRAM), a static RAM (SRAM), a synchronous dynamic RAM (SDRAM) and the like), a nonvolatile memory (for example, an one time programmable ROM (OTPROM), a programmable ROM (PROM), an erasable and programmable ROM (EPROM), an electrically erasable and programmable ROM (EEPROM), a mask ROM, a flash ROM and the like), a hard disk drive (HDD), and a solid state drive (SSD). According to an embodiment, the control unit 190 loads commands or data received from at least one of the nonvolatile memory and other elements to the volatile memory, and processes the commands or data. The control unit 190 stores data received from other elements or generated data in the nonvolatile memory.

The external memory 142 includes at least one of a compact flash (CF), a secure digital (SD), a micro-secure digital (SD), a mini-secure digital (SD), an extreme digital (xD), and a memory stick.

The memory unit 140 stores an operating system for controlling resources of the electronic device 100, application programs for operations of applications, and the like. The operating system can include a kernel, a middleware, an API and the like. For example, the Android, iOS, Windows, Symbian, Tizen or Bada operating system can be used as the operating system.

The kernel includes a system resource manager capable of managing resources and a device driver. The resource manager, for example, includes a controller management unit, a memory unit management unit, a file system management unit and the like, and performs functions of control, allocation, collection, and the like of system resources. The device driver accesses and controls various elements of the electronic device 100 in a software manner. To this end, the device driver can be divided into an interface and individual driver module parts provided by each hardware provider. The device driver, for example, includes at least one of a display driver, a camera driver, a Bluetooth driver, a shared memory driver, a USB driver, a keypad driver, a Wi-Fi driver, an audio driver, and an inter-process communication driver.

The middleware includes a plurality of modules for providing functions commonly required for various applications. The middleware provides commonly required functions through the API such that the applications can efficiently use limited system resources in the electronic device. The middleware, for example, includes at least one of an application manager, a window manager, a multimedia manager, a resource manager, a power manager, a database manager, and a package manager. Furthermore, the middleware includes at least one of a connectivity manager, a notification manager, a location manager, a graphic manager, and a security manager. Furthermore, the middleware includes a runtime library or other library modules according to an implementation example. The runtime library is a library module used by a compiler in order to add a new function through a programming language during the execution of an application. For example, the runtime library performs functions and the like for input and output, memory management, or an arithmetic function. The middleware also generates and uses a new middleware module through various function combinations of the aforementioned internal element modules. In order to provide differentiated functions, the middleware also provides modules specialized according to the type of an operating system.

The API is a set of API programming functions and can be configured to have other configurations according to an operating system. For example, in the case of Android or iOS, for example, an API set can be configured for each platform, and in the case of Tizen, for example, two API sets can be configured for each platform.

The application performs at least one function by using an application program. The application, for example, can be divided into a preloaded application and a third part application. The application, for example, can include a home application for displaying a home screen, a dialer application, a short message service (SMS)/multi-media message service (MMS) application, an instant message (IM) application, a browser application, a camera application, an alarm application, a contacts (or address book) application, a voice dial application, an E-mail application, a calendar application, a media application, an album application, a watch application, and the like.

The sensor unit 150 includes at least one of a gesture sensor 151, a gyro sensor 152, a time sensor 153, an acceleration sensor 154, a proximity sensor 155, a fingerprint scan sensor 156, a grip sensor 157, and an illuminance sensor 158.

The gesture sensor 151 is a non-contact sensor capable of detecting a gesture using the fingers of a user or a tool such as a stylus pen in a three-dimensional space. For example, the gesture sensor 151 detects a gesture using the fingers of a user or a tool such as a stylus pen in a three-dimensional space by using the camera unit 170 and the like, and transmits a detection signal to the control unit 190. The gesture sensor 151 also includes at least a part of the control unit 190. For example, the gesture sensor 151 includes an operation for correcting gesture information or obtaining the characteristic of the gesture information, in addition to an operation for acquiring the gesture information. In this case, the gesture sensor 151 includes a functional module having a hardware module and a software module.

The gyro sensor 152 measures a movement direction, an acceleration and the like of the electronic device 100. For example, the gyro sensor 152 detects a rotation direction of the electronic device 100, and the electronic device 100 displays a landscape or portrait screen interface on the display unit 110 according to the detected rotation direction. The gyro sensor 152 also includes at least a part of the control unit 190. For example, the gyro sensor 152 also includes an operation for correcting information on the movement direction and the acceleration and the like of the electronic device 100 or obtaining the characteristic of the information on the movement direction and the acceleration and the like of the electronic device 100, in addition to an operation for acquiring the movement direction and the acceleration and the like of the electronic device 100. In this case, the gyro sensor 152 includes a functional module having a hardware module and a software module.

The time sensor 153 detects a time of an area where the electronic device 100 is located.

The acceleration sensor 154 detects a movement on the space of the electronic device 100. For example, the acceleration sensor 154 detects a static state or a dynamic state of the electronic device 100. The acceleration sensor 154 also includes at least a part of the control unit 190. For example, the acceleration sensor 154 also includes an operation for correcting information on the movement on the space of the electronic device 100 or obtaining the characteristic of the information on the movement on the space of the electronic device 100, in addition to an operation for acquiring the movement on the space of the electronic device 100. In this case, the acceleration sensor 154 includes a functional module having a hardware module and a software module.

The proximity sensor 155 measures the distance between the electronic device 100 and a user or an object. For example, as the proximity sensor 155, a photodiode-based proximity sensor is used. The proximity sensor 155 includes a light transmitting unit and a light receiving unit, wherein the light transmitting unit generally includes a light emitting diode (LED) and a light receiving unit includes a photodiode. When the light transmitting unit allows light to pass therethrough, light irradiated to an object proximate to the proximity sensor is reflected, the reflected light is transferred to the light receiving unit, and the light receiving unit absorbs the transferred light to recognize that the object is proximate to the proximity sensor. The light receiving unit generates data for the amount (a light receiving amount) of the absorbed light, and the generated data is an index for determining the degree by which the object is proximate to the electronic device 100. The proximity sensor 155 also includes at least a part of the control unit 190. For example, the proximity sensor 155 also includes an operation for correcting information on the degree by which the object is proximate to the electronic device 100 or obtaining the characteristic of the information on the degree by which the object is proximate to the electronic device 100, in addition to an operation for acquiring the information on the degree by which the object is proximate to the electronic device 100. In this case, the proximity sensor 155 includes a functional module having a hardware module and a software module.

The fingerprint scan sensor 156 acquires a fingerprint image of a user in a touch swipe scheme or touch scheme of the user and detects the fingerprint of the user. Sensing data for the fingerprint image can be acquired by an optical, semiconductor, ultrasonic, or non-contact scheme.

The optical fingerprint scan sensor, for example, can include a prism, a light source, a lens, a charge-coupled device (CCD) and the like. In the optical sensor, when a fingerprint is brought into contact with the prism, the light source is irradiate light to the prism, the lens collects the light reflected through the prism, and the CCD acquires the collected light as a fingerprint image.

The semiconductor fingerprint scan sensor can include a thermal sensor, a capacitive sensor, an electric sensor and the like. Since the semiconductor fingerprint scan sensor can be manufactured in a small size, it can be used in application products used by an individual. The thermal sensor can be a fingerprint scan sensor that acquires a temperature distribution as a fingerprint image by a temperature difference between a contact part and a non-contact part of a fingerprint. The capacitive sensor can be a fingerprint scan sensor that acquires a difference of the amount of electrified charge or capacitance between ridges of a contacted fingerprint as a fingerprint image. The electric sensor can be a fingerprint scan sensor that acquires fingerprint image information from an electric field formed in a fingerprint contacted with the sensor or formed around the fingerprint.

The fingerprint scan sensor 156 also includes at least a part of the control unit 190. For example, the fingerprint scan sensor 156 also includes an operation for correcting a fingerprint image or obtaining the characteristic of the fingerprint image, in addition to an operation for acquiring the fingerprint image. In this case, the fingerprint scan sensor 156 includes a functional module having a hardware module and a software module.

Such a fingerprint scan sensor 156 can be mounted on one surface of a housing of the electronic device 100. Furthermore, the fingerprint scan sensor 156 can also have a structure combined with the key 123 of the electronic device 100. For example, the fingerprint scan sensor 156 can have a structure in which it is physically combined with a home button that is an example of the key 123 and one surface of the fingerprint scan sensor 156, which is contactable with a fingerprint, is exposed on the home button.

The grip sensor 157 operates when the electronic device 100 detects pressure exceeding constant pressure set by a user. For example, when a user makes contact with the grip sensor 157 included in the electronic device 100 with pressure exceeding the constant pressure, it is possible to detect the hand of the user who grips the grip sensor 157. The grip sensor 157 includes at least one piezoelectric sensor or piezo sensor formed at one side of the electronic device 100. For example, the grip sensor 157 includes a set of piezo sensors arranged at the left side and the right side of the electronic device 100 about the front surface of the display unit 110, and when a predetermined number of grip sensors are arranged at the left side or the right side and the electronic device 100 is gripped by the left hand or the right hand of a user, it is possible to detect pressure generated according to the positions of the fingers of the user. The grip sensor 157 can also include at least a part of the control unit 190. For example, the grip sensor 157 also includes an operation for correcting information on the hand of a user gripping the electronic device 100 or obtaining the characteristic of the information on the hand of a user gripping the electronic device 100, in addition to an operation for acquiring the information on the hand of a user gripping the electronic device 100. In this case, the grip sensor 157 includes a functional module having a hardware module and a software module.

The illuminance sensor 158 detects an optical signal transmitted from a light source, converts the optical signal into an electrical signal, and outputs the electrical signal. The illuminance sensor 158 detects a visible ray area by using a photodiode or CdS photoconductive cells, and detect illuminance around the electronic device 100. The gesture sensor 151, the proximity sensor 155, and the illuminance sensor 158 performs a detection operation by using a photodiode included in the camera unit 170.

The audio unit 160 bidirectionally converts voice and an electrical signal. The audio unit 160, for example, includes at least one of a speaker, a receiver, an earphone, and a microphone, and convert input or output voice information.

The camera unit 170 performs a function of capturing an image and a moving picture. The camera unit 170 includes one or more image sensors, an image signal processor (ISP), or a flash LED according to an implementation example. The camera unit 170 can use a photodiode, which uses a property that a current flows when light is received, as a light receiving element that receives an optical signal, or can include an image sensor such as a charge-coupled device (CCD) or a complementary metal oxide semiconductor (CMOS) sensor. An optical signal is converted into an electrical signal for output through such a light receiving element.

The motor 180 converts an electrical signal into mechanical vibration.

The control unit 190 drives an operating system and an application program, thereby controlling a plurality of hardware and software elements connected to the control unit 190, and performing the processing and operation of various types of data including multimedia data. The control unit 190, for example, can be implemented with a system on chip (SoC) and can further include a graphic processing unit (GPU). For example, the control unit 190 determines the coincidence or non-coincidence of a password transferred through the user input unit 120 and the coincidence or non-coincidence of password input conditions preset by a user. Depending on the coincidence or non-coincidence of the password and the coincidence or non-coincidence of the password input conditions, the control unit 190 performs at least one function provided by the electronic device 100. For example, depending on the coincidence or non-coincidence of the password and the coincidence or non-coincidence of the password input conditions, the electronic device 100 receives a signal for requesting the removal of a lock screen, switching from an off screen to an on screen, requesting the display of a home screen provided by the electronic device 100, requesting the execution of an application being executed by the electronic device 100, requesting the execution of at least one application provided by the electronic device 100, or requesting the execution of at least one function of the application being executed by the electronic device 100. The signal for requesting the execution of at least one function is normally generated when there is user's input through the user input unit 120, but can be automatically generated by the electronic device 100 regardless of a user.

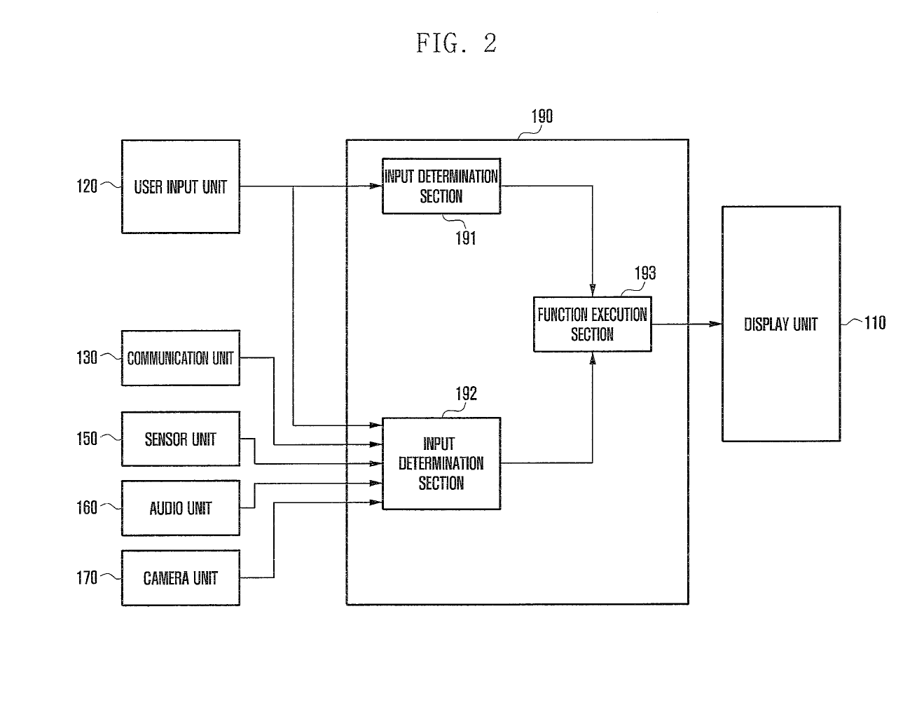

FIG. 2 is a block diagram illustrating an example configuration of the control unit 190 according to this disclosure.

The control unit 190 includes an input determination section module 191, an input condition determination section module 192, and a function execution section module 193. The modules 191 to 193 of the control unit 190 follow the convenience of description, and at least a part of the modules 191 to 193 can have various shapes through omission, modification, combination and the like. Furthermore, the modules 191 to 193 may be implemented by hardware, software, or a combination of the hardware and the software.

The control unit 190 determines passwords and password input conditions preset by a user, and passwords input from the user for function execution, and input conditions at the time of password input. When the preset password and the password input condition coincide with the password input from the user and the password input condition, it is possible to execute at least one function provided by the electronic device 100.

In an embodiment, the password input condition can be a rotation state of the electronic device 100. For example, a user sets the input condition such that at least one function provided by the electronic device 100 is executed according to a password input in a landscape mode of the electronic device 100 at the time of password input. In this case, when the user inputs a password to the electronic device 100 in a portrait mode of the electronic device 100, even though the password input in the portrait mode of the electronic device 100 coincides with the password input in the landscape mode of the electronic device 100, the control unit 190 may not execute the function provided by the electronic device 100, deactivate a password input field such that no password is input, or block the execution of the function provided by the electronic device 100. The rotation state of the electronic device 100 is detected by the gyro sensor 152. The function provided by the electronic device 100 includes at least one of the removal request of a lock screen, the switching from an off screen to an on screen, the display request of a home screen provided by the electronic device 100, the execution request of an application being executed by the electronic device 100, the execution request of at least one application provided by the electronic device 100, and the execution request of at least one function of the application being executed by the electronic device 100.

The password input condition can also be a grip state of the electronic device 100. For example, a user sets the input condition such that at least one function provided by the electronic device 100 is executed according to a password input in the state in which the user grips the electronic device 100 with his/her left hand at the time of password input. In this case, when the user inputs a password to the electronic device 100 in the state in which the user grips the electronic device 100 with his/her right hand, even though the password input in the state in which the user grips the electronic device 100 with his/her left hand coincides with the password input in the state in which the user grips the electronic device 100 with his/her right hand, the control unit 190 may not execute the function provided by the electronic device 100, deactivate the password input field such that no password is input, or block the execution of the function provided by the electronic device 100. The grip state of the electronic device 100 by the user is detected by the grip sensor 157.

The password input condition can also be a password input means. For example, a user sets the input condition such that at least one function provided by the electronic device 100 is executed according to a password input by a pen. In this case, when the user inputs a password to the electronic device 100 with his/her finger, even though the password input by the pen coincides with the password input by the finger, the control unit 190 may not execute the function provided by the electronic device 100, deactivate the password input field such that no password is input, or block the execution of the function provided by the electronic device 100. The input means is detected by the user input unit 120.

The password input condition can also be a time. For example, a user sets the input condition such that at least one function provided by the electronic device 100 is executed according to a password input at a specific time (for example, from 7:00 PM to 7:00 AM in the next day). In this case, when the user inputs a password to the electronic device 100 at a time other than the specific time, even though the password input at the specific time coincides with the password input at the time other than the specific time, the control unit 190 may not execute the function provided by the electronic device 100, deactivate the password input field such that no password is input, or block the execution of the function provided by the electronic device 100. The time is detected by the time sensor 153 or the communication unit 130.

The password input condition can also be a place. For example, a user sets the input condition such that at least one function provided by the electronic device 100 is executed according to a password input at a specific place (for example, a home or an office of a user). In this case, when the user inputs a password to the electronic device 100 at a place other than the specific place, even though the password input at the specific place coincides with the password input at the place other than the specific place, the control unit 190 may not execute the function provided by the electronic device 100, deactivate the password input field such that no password is input, or block the execution of the function provided by the electronic device 100. The place is detected by the communication unit 130, for example, the location information section 134, or the illuminance sensor 158.

The password input condition can also be mobile device management (MDM) activation. For example, a user sets the input condition such that at least one function provided by the electronic device 100 is executed according to a password input in the case in which MDM has been activated. In this case, when the user inputs a password to the electronic device 100 in the case in which the MDM has been deactivated, even though the password input in the case in which the MDM has been activated coincides with the password input in the case in which the MDM has been deactivated, the control unit 190 may not execute the function provided by the electronic device 100, deactivate the password input field such that no password is input, or block the execution of the function provided by the electronic device 100.

The password input condition can also be the recognition of a user's face or the recognition of a user's specific gesture. For example, when there is the recognition of a user's face or the recognition of a user's specific gesture at the time of password input, a user sets the input condition such that at least one function provided by the electronic device 100 is executed according to an input password. In this case, when the user inputs a password to the electronic device 100 in the case in which there is no recognition of a user's face or no recognition of a user's specific gesture, even though the password input in the case in which there is the recognition of a user's face or the recognition of a user's specific gesture at the time of the password input coincides with the password input in the case in which there is no recognition of a user's face or no recognition of a user's specific gesture at the time of the password input, the control unit 190 may not execute the function provided by the electronic device 100, deactivate the password input field such that no password is input, or block the execution of the function provided by the electronic device 100. The user's face or the user's specific gesture is recognized by at least one of the camera unit 170, the gesture sensor 151, and the proximity sensor 155.

The password input condition can be a control environment setting state of the electronic device 100, such as a communication connection or vibration function setting. For example, a user sets the input condition such that at least one function provided by the electronic device 100 is executed according to the control environment setting state of the electronic device 100, such as a communication connection or vibration function setting at the time of password input. The control environment setting includes at least one of the turning on or off of Bluetooth, the turning on or off of WiFi, the turning on or off of near field communication (NFC), and the turning on or off of a communication connection vibration alarm. When the input condition is set, the function provided by the electronic device 100 is executed according to a password input in the case in which the Bluetooth function is turned on, the WiFi function is turned off, the NFC function is turned off, and the communication connection vibration alarm function is turned on. Accordingly, when there is password input in the state different from the control environment setting state of the electronic device 100, which has been previously set as the input condition, even though the input passwords coincide with each other, the control unit 190 may not execute the function provided by the electronic device 100, deactivate the password input field such that no password is input, or block the execution of the function provided by the electronic device 100.

The password input condition can be the recognition of a user's fingerprint. For example, a user sets the input condition such that at least one function provided by the electronic device 100 is executed according to a password input in the case in which there is the recognition of a user's fingerprint at the time of password input. In this case, when the user inputs a password to the electronic device 100 in the case in which there is no recognition of a user's fingerprint, even though the password input in the case in which there is the recognition of a user's fingerprint coincides with the password input in the case in which there is no recognition of a user's fingerprint, the control unit 190 may not execute the function provided by the electronic device 100, deactivate the password input field such that no password is input, or block the execution of the function provided by the electronic device 100. The recognition of a user's fingerprint is recognized by the fingerprint scan sensor 156.

The password input condition can be the recognition of user' voice. For example, a user sets the input condition such that at least one function provided by the electronic device 100 is executed according to a password input in the case in which there is the recognition of user' voice at the time of password input. In this case, when the user inputs a password to the electronic device 100 in the case in which there is no recognition of user' voice, even though the password input in the case in which there is the recognition of user' voice coincides with the password input in the case in which there is no recognition of user' voice, the control unit 190 may not execute the function provided by the electronic device 100, deactivate the password input field such that no password is input, or block the execution of the function provided by the electronic device 100. The recognition of user' voice is recognized by the audio unit 160.

The password input condition can be a power saving mode. For example, a user sets the input condition such that at least one function provided by the electronic device 100 is executed according to a password input in the case in which the power saving mode has been activated. In this case, when the user inputs a password to the electronic device 100 in the case in which the power saving mode has been deactivated, even though the password input in the case in which the power saving mode has been activated coincides with the password input in the case in which the power saving mode has been deactivated, the control unit 190 may not execute the function provided by the electronic device 100, deactivate the password input field such that no password is input, or block the execution of the function provided by the electronic device 100.

The control unit 190 determines the coincidence or non-coincidence of the password transferred through the user input unit 120 and the coincidence or non-coincidence of the password input conditions previously set by a user. Depending on the coincidence or non-coincidence of the password and the coincidence or non-coincidence of the password input conditions, the control unit 190 executes at least one function provided by the electronic device 100. For example, depending on the coincidence or non-coincidence of the password and the coincidence or non-coincidence of the password input conditions, the control unit 190 receives a signal for requesting the removal of a lock screen, switching from an off screen to an on screen, requesting the display of a home screen provided by the electronic device 100, requesting the execution of an application being executed by the electronic device 100, requesting the execution of at least one application provided by the electronic device 100, or requesting the execution of at least one function of the application being executed by the electronic device 100. The signal for requesting the execution of at least one function may be normally generated when there is user's input through the user input unit 120, but can be automatically generated by the electronic device 100 regardless of a user.

The input determination section 191 determines whether the password transferred from the user input unit 120 coincides with the preset password. For example, the password transferred from the user input unit 120 includes at least one of a signature scheme in which at least one user performs touch input, a personal identification number (PIN) scheme of a combination of texts and/or numerals, and a pattern scheme in which touch input of a specific pattern by a user is recognized as a password. The input determination section 191 determines whether the input password coincides with the preset password, and transfers the determination result to the function execution section 193.

The input condition determination section 192 determines whether a password is input according to the preset password input conditions. The input condition determination section 192 determines whether a password is input according to the preset password input conditions, by using a signal detected by at least one of the communication unit 130, the sensor unit 150, the audio unit 160, and the camera unit 170. For example, the input conditions includes at least one of the rotation state of the electronic device 100 at the time of password input, the grip state of the electronic device 100 by a user at the time of password input, the password input means (for example, touch input by a finger or touch input by a pen), the password input time, the password input place, the recognition of coincidence or non-coincidence with the preset user's face or gesture through the camera unit 170 at the time of password input, the control environment setting state of the electronic device 100, such as a communication connection or vibration function setting of the electronic device 100 at the time of password input, the MDM activation state of the electronic device 100 at the time of password input, the user fingerprint recognition at the time of password input, the power saving mode activation state of the electronic device 100 at the time of password input, and the recognition of coincidence or non-coincidence with the preset user's voice at the time of password input. The input condition determination section 192 determines whether at least one of the input conditions coincides with the preset input conditions, and transfers a determination result to the function execution section 193, wherein the input conditions include at least one of the rotation state of the electronic device 100 at the time of password input, the grip state of the electronic device 100 by a user at the time of password input, the password input means (for example, touch input by a finger or touch input by a pen), the password input time, the password input place, the recognition of coincidence or non-coincidence with the preset user's face or gesture through the camera unit 170 at the time of password input, the user fingerprint recognition at the time of password input, the control environment setting state of the electronic device 100, such as a communication connection or vibration function setting of the electronic device 100 at the time of password input, the power saving mode state of the electronic device 100 at the time of password input, the MDM activation state of the electronic device 100 at the time of password input, and the recognition of coincidence or non-coincidence with the preset user's voice at the time of password input. The password input conditions includes a password not displayed on the display unit 110, which is recognized only by a user, at the time of password input. The password input conditions includes an invisible password in addition to a visible password such as a sign, a text, or a gesture.

The mobile device management (MDM) is for reducing business risk according to the characteristics of a portable electronic device such as a smart phone or a tablet PC, and optimizing the function and security of an electronic device in a company, relates to a series of mobile solutions that protect, manage, monitor, and support the electronic device, and when the electronic device 100 is positioned at a specific place (for example, the mobile device management), the MDM can be automatically activated to improve the security of the electronic device 100.

The function execution section 193 executes the removal request of a lock screen, the switching from an off screen to an on screen, the display request of a home screen provided by the electronic device 100, the execution request of an application being executed by the electronic device 100, the execution request of at least one application provided by the electronic device 100, or the execution request of at least one function of the application being executed by the electronic device 100, according to signals received from the input determination section 191 and the input condition determination section 192, and provide the display unit 110 with the function execution result. Depending on a signal regarding the coincidence of the preset password transferred from the input determination section 191 and an input password and a signal regarding the coincidence of the preset password input conditions transferred from the input condition determination section 192 and input conditions at the time of password input, the function execution section 193 executes the removal request of a lock screen, the switching from an off screen to an on screen, the display request of a home screen provided by the electronic device 100, the execution request of an application being executed by the electronic device 100, the execution request of at least one application provided by the electronic device 100, or the execution request of at least one function of the application being executed by the electronic device 100, and provides the display unit 110 with the function execution result.

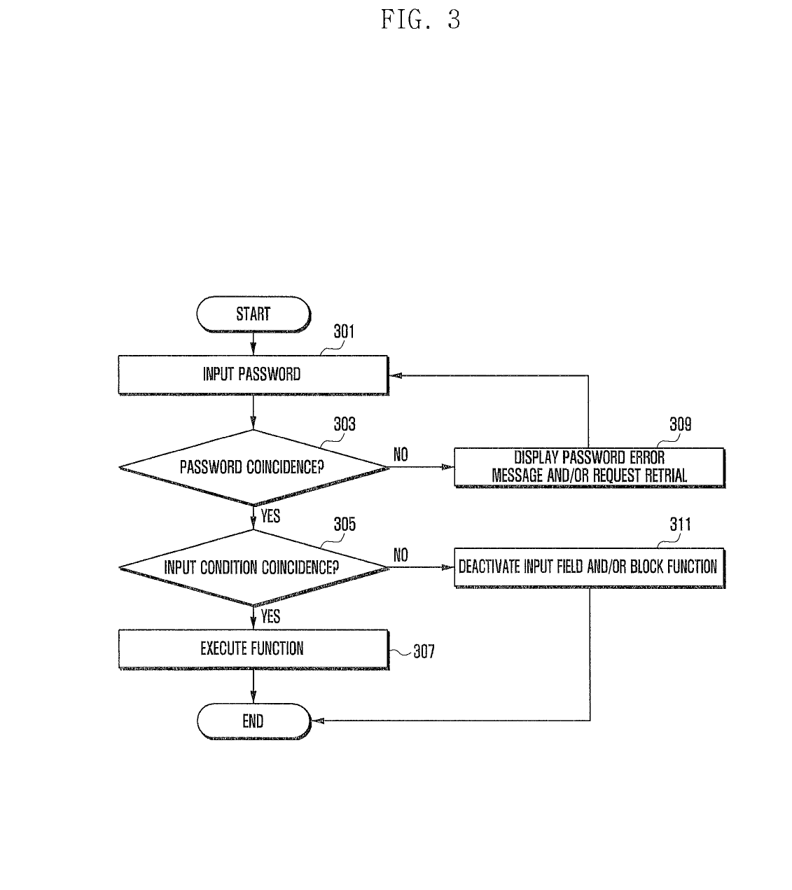

FIG. 3 is a flowchart illustrating an example authentication method using a password of the electronic device according to this disclosure.

In step 301, the electronic device 100 receives a password from a user. The password includes at least one of a signature scheme, a personal identification number (PIN) scheme of a combination of texts and/or numerals, and a pattern scheme in which touch input of a specific pattern by a user is recognized as a password.

In step 303, the electronic device 100 compares the password received from the user with a stored password. In step 303, the electronic device 100 determines whether the password received from the user coincides with the stored (such as preset) password.

When the password received from the user does not coincide with the stored (such as preset) password, the electronic device 100 displays a password input error message and a retrial request, or displays the password input error message or the retrial request through the display unit 110 thereof in step 309.

When the password received from the user coincides with the stored (such as preset) password, the electronic device 100 determines whether the preset password input conditions coincide with input conditions at the time of password input in step 305. The password input conditions include at least one of the rotation state of the electronic device 100 at the time of password input, the grip state of the electronic device 100 by a user at the time of password input, the password input means (for example, touch input by a finger or touch input by a pen), the password input time, the password input place, the recognition of coincidence or non-coincidence with the preset user's face or gesture through the camera unit 170 at the time of password input, the control environment setting state of the electronic device 100, such as a communication connection or vibration function setting of the electronic device 100 at the time of password input, the MDM activation state of the electronic device 100 at the time of password input, the user fingerprint recognition at the time of password input, the power saving mode activation state of the electronic device 100 at the time of password input, and the recognition of coincidence or non-coincidence with the preset user's voice at the time of password input.

When the preset password input conditions coincide with the input conditions at the time of password input, the electronic device 100 executes the function provided by the electronic device 100 in step 307. The function provided by the electronic device 100 includes at least one of the removal request of a lock screen, the switching from an off screen to an on screen, the display request of a home screen provided by the electronic device 100, the execution request of an application being executed by the electronic device 100, the execution request of at least one application provided by the electronic device 100, and the execution request of at least one function of the application being executed by the electronic device 100.

When the preset password input conditions do not coincide with the input conditions at the time of password input, the electronic device 100 deactivates the password input field or blocks the function execution in step 311. Alternatively, when the preset password input conditions do not coincide with the input conditions at the time of password input, the electronic device 100 deactivates the password input field and blocks the function execution in step 311.

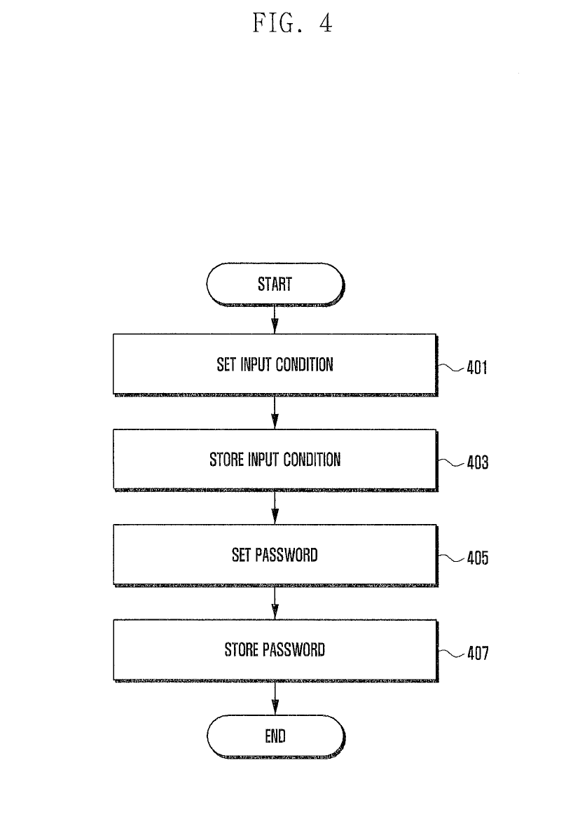

FIG. 4 is a flowchart illustrating an example password setting method of the electronic device according to this disclosure.

In step 401, the electronic device 100 sets input conditions at the time of password input. The password input conditions include at least one of the rotation state of the electronic device 100 at the time of password input, the grip state of the electronic device 100 by a user at the time of password input, the password input means (for example, touch input by a finger or touch input by a pen), the password input time, the password input place, the recognition of coincidence or non-coincidence with the preset user's face or gesture through the camera unit 170 at the time of password input, the control environment setting state of the electronic device 100, such as a communication connection or vibration function setting of the electronic device 100 at the time of password input, the MDM activation state of the electronic device 100 at the time of password input, the user fingerprint recognition at the time of password input, the power saving mode activation state of the electronic device 100 at the time of password input, and the recognition of coincidence or non-coincidence with the preset user's voice at the time of password input. In step 401, the electronic device 100 receives an input condition selected from a user at the time of password input condition setting.

In step 403, the electronic device 100 stores the set input condition. In step 403, the electronic device 100 stores the input condition selected from the user at the time of password input condition setting.

In step 405, the electronic device 100 sets a password. The password includes at least one of a signature scheme, a personal identification number (PIN) scheme of a combination of texts and/or numerals, and a pattern scheme in which touch input of a specific pattern by a user is recognized as a password. In step 405, the electronic device 100 receives a password selected from the user.

In step 407, the electronic device 100 stores the set password. In step 407, the electronic device 100 stores the password selected from the user.

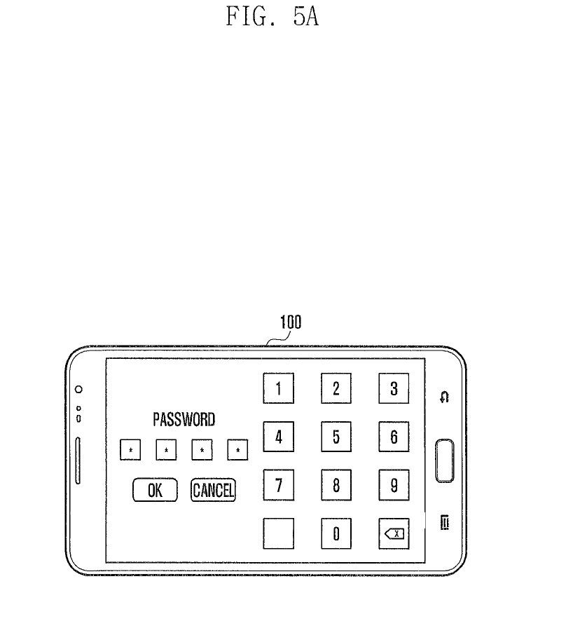

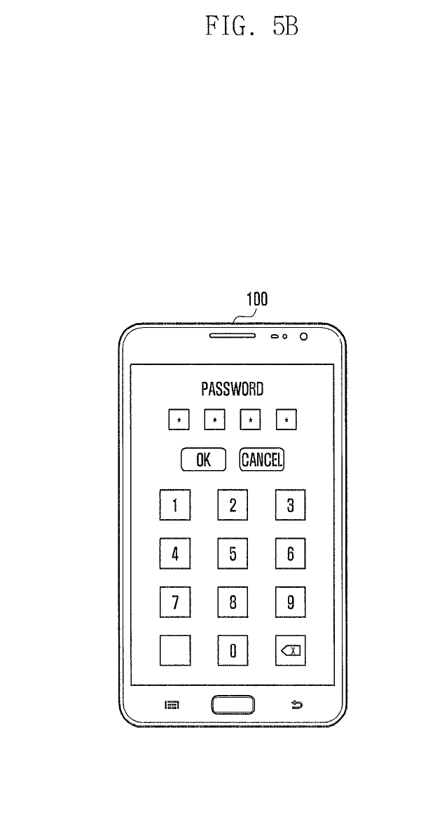

FIGS. 5A to 9B are diagrams illustrating example authentication methods using a password of the electronic device 100 according to this disclosure.

FIGS. 5A and 5B are diagrams illustrating an example authentication method using a password of the electronic device 100 when the password input condition is the rotation state of the electronic device 100. A user may set the input condition such that at least one function provided by the electronic device 100 is executed according to a password input in a landscape mode of the electronic device 100 at the time of password input as illustrated in FIG. 5A. In this case, when the user inputs a password to the electronic device 100 in a portrait mode of the electronic device 100 as illustrated in FIG. 5B, even though the password input in the portrait mode of the electronic device 100 coincides with the password input in the landscape mode of the electronic device 100, the function provided by the electronic device 100 may not be executed, the password input field can be deactivated such that no password is input, or the execution of the function provided by the electronic device 100 can be blocked. The rotation state of the electronic device 100 is detected by the gyro sensor 152. The function provided by the electronic device 100 includes at least one of the removal request of a lock screen, the switching from an off screen to an on screen, the display request of a home screen provided by the electronic device 100, the execution request of an application being executed by the electronic device 100, the execution request of at least one application provided by the electronic device 100, and the execution request of at least one function of the application being executed by the electronic device 100.

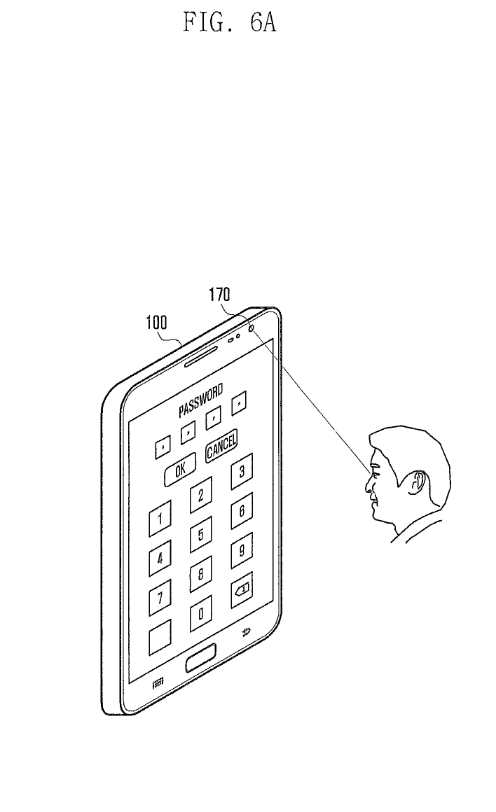

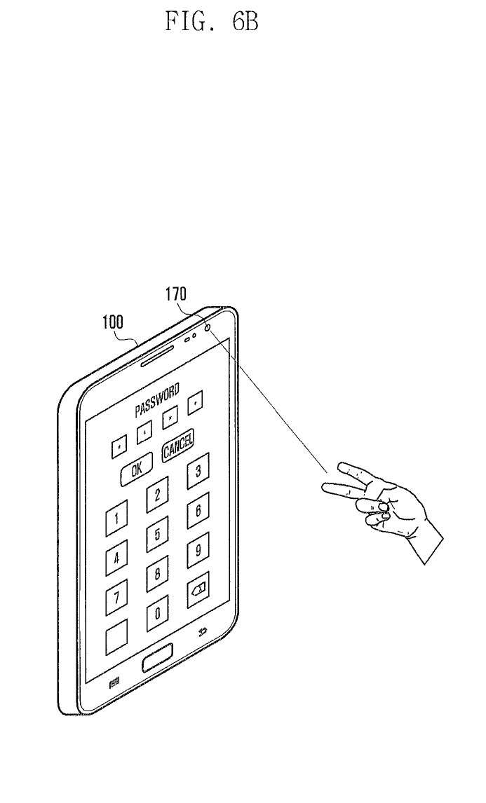

FIGS. 6A and 6B are diagrams illustrating an authentication method using a password of the electronic device 100 when the password input condition is the recognition of a user's face as illustrated in FIG. 6A or the recognition of a user's specific gesture as illustrated in FIG. 6B. When there is the recognition of a user's face as illustrated in FIG. 6A or the recognition of a user's specific gesture as illustrated in FIG. 6B at the time of password input, a user may set the input condition such that at least one function provided by the electronic device 100 is executed according to an input password. In this case, when the user inputs a password to the electronic device 100 in the case in which there is no recognition of a user's face or no recognition of a user's specific gesture at the time of the password input, even though the password input in the case in which there is the recognition of a user's face or the recognition of a user's specific gesture face as illustrated in FIGS. 6A or 6B at the time of the password input coincides with the password input in the case in which there is no recognition of a user's face or no recognition of a user's specific gesture at the time of the password input, the function provided by the electronic device 100 may not be executed, the password input field may be deactivated such that no password is input, or the execution of the function provided by the electronic device 100 may be blocked. The recognition of a user's face or the recognition of a user's specific gesture is recognized by at least one of the camera unit 170, the gesture sensor 151, and the proximity sensor 155 included in the front surface of the electronic device 100.

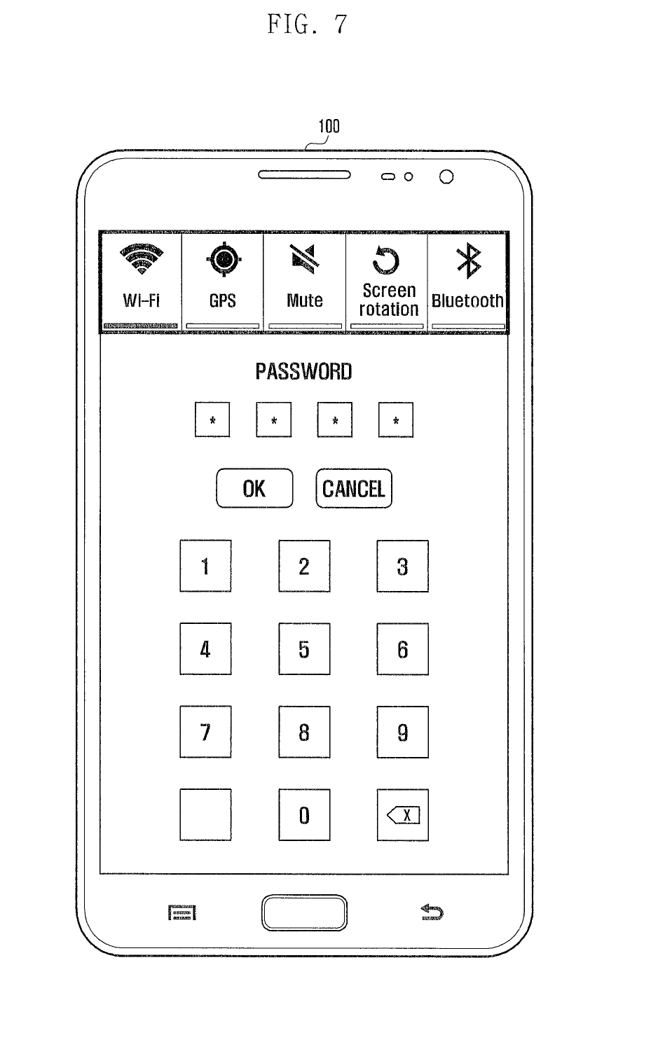

FIG. 7 is a diagram illustrating an example authentication method using a password of the electronic device 100 when the password input condition is the control environment setting state of the electronic device 100 such as a communication connection or vibration function setting.

A user sets the input condition such that at least one function provided by the electronic device 100 is executed according to the control environment setting state of the electronic device 100, such as a communication connection or vibration function setting at the time of password input. The control environment setting includes at least one of the turning on or off of Bluetooth, the turning on or off of WiFi, the turning on or off of a global position system (GPS), the turning on or off of a communication connection vibration alarm, and the turning on or off of screen rotation. At illustrated in FIG. 7, the function provided by the electronic device 100 is executed according to a password input in the case in which the control environment is set such that the WiFi function is turned on, the global position system (GPS) function is turned off, the communication connection vibration function (a mute function) is turned off, the screen rotation is turned off, and the Bluetooth (BT) is turned off Accordingly, when there is password input in the state different from the control environment setting state of the electronic device 100, which has been previously set as the input condition, even though the input passwords coincide with each other, the function provided by the electronic device 100 may not be executed, the password input field may be deactivated such that no password is input, or the execution of the function provided by the electronic device 100 may be blocked. The electronic device 100 provides the control environment setting, such as the turning on or off of Bluetooth, the turning on or off of WiFi, the turning on or off of a global position system (GPS), the turning on or off of a communication connection vibration alarm (a mute function), and the turning on or off of screen rotation, to the display unit 110 through a user interface in the form of a control center.

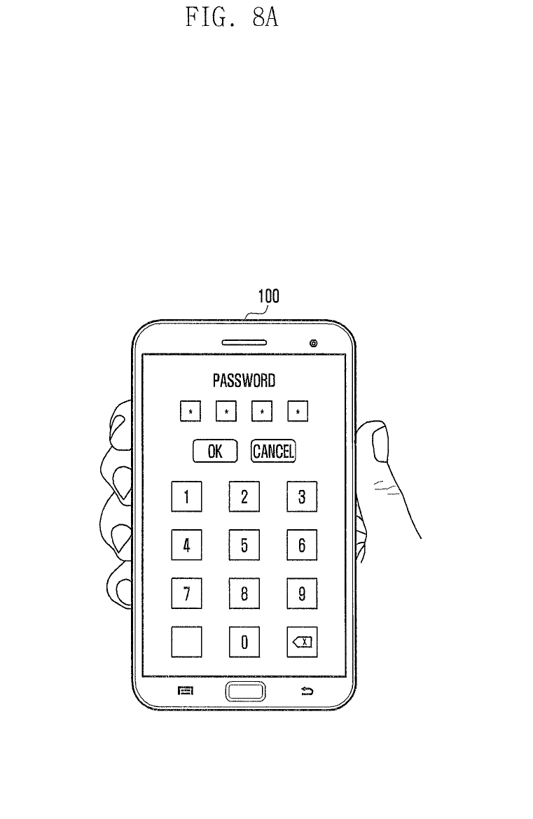

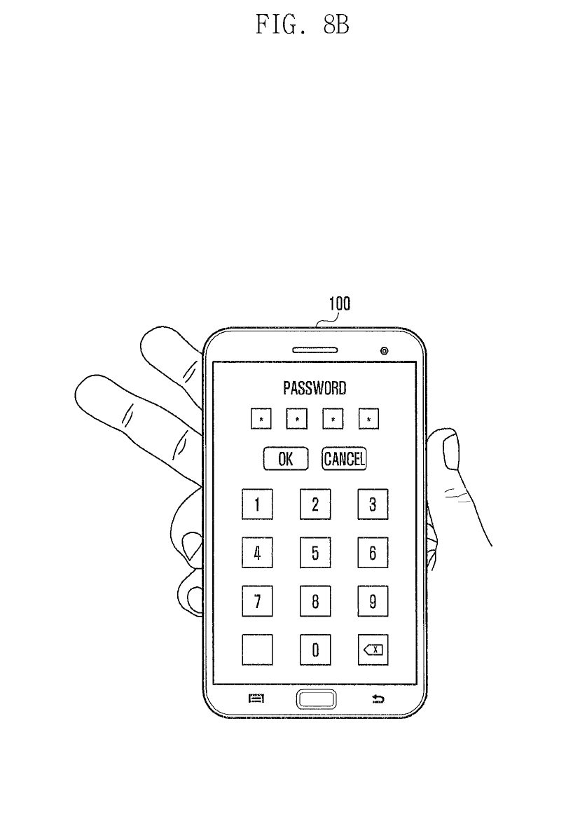

FIGS. 8A and FIG. 8B are diagrams illustrating an authentication method using a password of the electronic device 100 when the password input condition is the grip state of the electronic device 100.

For example, in FIG. 8A, a user sets the input condition such that at least one function provided by the electronic device 100 is executed according to a password input in the state in which the user grips the electronic device 100 with only his/her right or left hand at the time of password input. In FIG. 8B, a user sets the input condition such that at least one function provided by the electronic device 100 is executed only when the user designates at least one specific finger and grips the electronic device 100 with the at least one specific finger even though the user grips the electronic device 100 with his/her one hand at the time of password input. In this case, when the user inputs a password to the electronic device 100 in the state in which the user grips the electronic device 100 with his/her left hand, even though the password input in the state in which the user grips the electronic device 100 with his/her right hand coincides with the password input in the state in which the user grips the electronic device 100 with his/her left hand, the function provided by the electronic device 100 may not be executed, the password input field may be deactivated such that no password is input, or the execution of the function provided by the electronic device 100 may be blocked. The grip state of the electronic device 100 by the user is detected by the grip sensor 157. Alternatively, when a user inputs a password to the electronic device 100 with at least one specific finger designated by the user, even though the password input using the at least one specific finger designated by the user coincides with the password input using a finger not designated by the user, the function provided by the electronic device 100 may not be executed, the password input field may be deactivated such that no password is input, or the execution of the function provided by the electronic device 100 may be blocked.

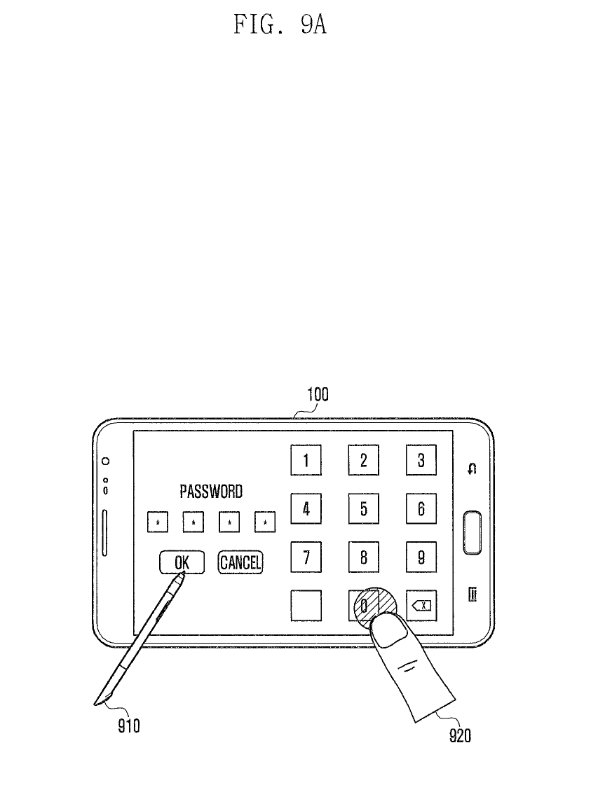

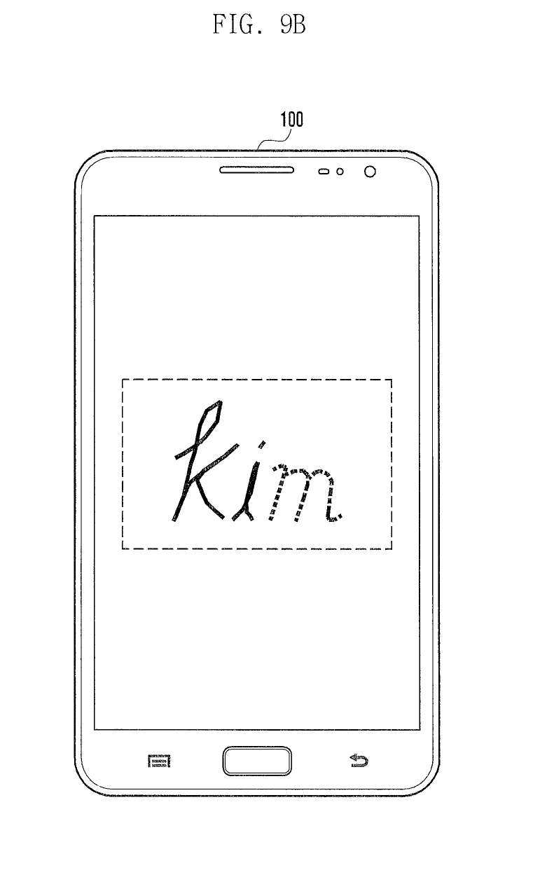

FIG. 9A is a diagram illustrating an example authentication method using a password of the electronic device 100 when the password input condition is a password input means.

A user sets the input condition such that at least one function provided by the electronic device 100 is executed according to a password input by a pen 910. In this case, when the user inputs a password to the electronic device 100 with his/her finger 920, even though the password input by the pen 910 coincides with the password input by the finger 920, the function provided by the electronic device 100 may not be executed, the password input field may be deactivated such that no password is input, or the execution of the function provided by the electronic device 100 may be blocked. The input means is detected by the user input unit 120.

FIG. 9B is a diagram illustrating an example authentication method using a password of the electronic device 100 when the password input conditions are a password input means and a signature.

A user sets the input condition such that at least one function provided by the electronic device 100 is executed according to the password input means and the signature. For example, it is possible to validate only a password input in the state in which a user inputs a signature “ki” to the electronic device 100 with his/her finger 920 and inputs a signature “m” to the electronic device 100 with the pen 910 at the time of password input. Furthermore, the electronic device 100 can preset a signature “kim” and determine whether the signature is valid handwriting. Accordingly, when a signature is not input in a preset scheme or is not preset handwriting, even though passwords input with the finger 920 coincide with each other, the function provided by the electronic device 100 may not be executed, the password input field may be deactivated such that no password is input, or the execution of the function provided by the electronic device 100 may be blocked. The input means may be detected by the user input unit 120.

It should be understood by those skilled in the art that the above described embodiments are only embodiments and are not restrictive since the embodiments can be implemented in other concrete forms without any change in the technical idea or essential characteristics of the present disclosure. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An authentication method using a password of an electronic device, the method comprising:
receiving a password;
determining whether the received password coincides with a password stored in advance;
determining whether an input condition at a time of password input coincides with a password input condition stored in advance when the received password coincides with the password stored in advance; and
executing a function when the input condition at the time of password input coincides with the password input condition stored in advance.

2. The method of claim 1, further comprising:
deactivating an input field to which the password is input or blocking execution of the function when the input condition at the time of password input does not coincide with the password input condition stored in advance.

3. The method of claim 1, further comprising:
displaying a password error message or requesting a password input retrial when the received password does not coincide with the password stored in advance.

4. The method of claim 1, wherein the password includes at least one of a signature scheme, a personal identification number scheme, and a pattern scheme.

5. The method of claim 4, wherein the password input condition includes an invisible password in addition to the signature scheme, the personal identification number scheme, and the pattern scheme at the time of password input.

6. The method of claim 5, wherein the password input condition includes at least one of a rotation state of the electronic device, a grip state of the electronic device, a password input means, a password input time, a password input place, recognition of a user's face, recognition of a user's gesture, recognition of a user's fingerprint, recognition of user's voice, a control environment setting state of the electronic device, a power saving mode state of the electronic device, and a mobile device management (MDM) activation state of the electronic device.

7. The method of claim 1, wherein the function includes at least one of a removal request of a lock screen, switching from an off screen to an on screen, a display request of a home screen provided by the electronic device, an execution request of an application being executed by the electronic device, an execution request of at least one application provided by the electronic device, or an execution request of at least one function of the application being executed by the electronic device.

8. The method of claim 1, further comprising:
setting the password input condition;
storing the set password input condition;
setting the password; and
storing the set password.

9. An electronic device comprising:
a user input unit configured to receive a password from a user;
a memory unit configured to store a password stored in advance and an input condition of the password stored in advance;
a control unit configured to determine whether the received password coincides with the password stored in advance, determine whether an input condition at a time of password input coincides with the input condition of the password stored in advance when the received password coincides with the password stored in advance, and execute a function when the input condition at the time of password input coincides with the input condition of the password stored in advance; and
a display unit configured to display the function executed by the control unit.

10. The electronic device of claim 9, wherein, when the input condition at the time of password input does not coincide with the input condition of the password stored in advance, the control unit is configured to deactivate an input field to which the password is input or block execution of the function.

11. The electronic device of claim 9, wherein, when the received password does not coincide with the password stored in advance, the control unit is configured to display a password error message on the display unit or request a password input retrial.

12. The electronic device of claim 9, wherein the password includes at least one of a signature scheme, a personal identification number scheme, and a pattern scheme.

13. The electronic device of claim 12, wherein the password input condition includes an invisible password in addition to the signature scheme, the personal identification number scheme, and the pattern scheme at the time of password input.

14. The electronic device of claim 13, wherein the password input condition includes at least one of a rotation state of the electronic device, a grip state of the electronic device, a password input means, a password input time, a password input place, recognition of a user's face, recognition of a user's gesture, recognition of a user's fingerprint, recognition of user's voice, a control environment setting state of the electronic device, a power saving mode state of the electronic device, and a mobile device management (MDM) activation state of the electronic device.

15. The electronic device of claim 9, wherein the function includes at least one of a removal request of a lock screen, switching from an off screen to an on screen, a display request of a home screen provided by the electronic device, an execution request of an application being executed by the electronic device, an execution request of at least one application provided by the electronic device, or an execution request of at least one function of the application being executed by the electronic device.

16. The electronic device of claim 9, wherein the control unit is configured to set the password input condition, store the set password input condition in the memory unit, set the password, and store the set password in the memory unit.

17. A method of configuring an electronic device for password authentication, the method comprising:
setting a first password input condition;
storing the first password input condition;
setting a first password; and
storing the first password.

18. The method of claim 17, further comprising:
receiving a second password;
determining whether the second password coincides with the first password;
determining whether a second password input condition at a time of receiving the second password coincides with the first password input condition when the second password coincides with the first password; and
executing a function when the second password input condition at the time of receiving the second password coincides with the first password input condition.

19. The method of claim 18, wherein the first password and the second password includes at least one of a signature scheme, a personal identification number scheme, and a pattern scheme.

20. The method of claim 17, wherein the function includes at least one of a removal request of a lock screen, switching from an off screen to an on screen, a display request of a home screen provided by the electronic device, an execution request of an application being executed by the electronic device, an execution request of at least one application provided by the electronic device, or an execution request of at least one function of the application being executed by the electronic device.
